(19) United States
(12) Patent Application Publication
(10) Pub. No.: US 2025/0277520 A1
(43) Pub. Date: Sep. 4, 2025

(54) MULTI-SPEED CONCENTRIC TWIN-SHAFT TRANSMISSION

(71) Applicant: Eaton Intelligent Power Limited, Dublin (IE)

(72) Inventors: Caleb L. GURD, Battle Creek, MI (US); Carlos Henrique WINK, Portage, MI (US); Carlos Alberto FONTANA, Itatiba (BR)

(73) Assignee: Eaton Intelligent Power Limited, Dublin (IE)

(21) Appl. No.: 18/702,536

(22) PCT Filed: Oct. 18, 2022
(86) PCT No.: PCT/EP2022/025475

§ 371 Date: Apr. 18, 2024

Related U.S. Application Data
(60) Provisional application No. 63/256,702, filed on Oct. 18, 2021.

(51) Int. Cl. F16H 3/097; F16H 3/085; F16H 57/02; F16H 63/24; F16H 63/30

(52) U.S. Cl. CPC F16H 3/097; F16H 3/085; F16H 63/24; F16H 63/3013; F16H 63/304; F16H 2057/02026; F16H 2063/3093; F16H 2200/0004; F16H 2200/0021; F16H 2200/0043

(57) ABSTRACT

A transmission can include a shaft arrangement including an input shaft configured to couple to a primer mover and an output shaft coaxially aligned with the input shaft; a plurality of drive gears supported by the shaft arrangement and including a first drive gear, a second drive gear, and a third drive gear; a countershaft arrangement including a first and second countershaft supporting a plurality of pinion gears intermeshed with the first, second, and third drive gears; a clutch arrangement including a first clutch assembly and a second clutch assembly operable to lock the first, second, and third drive gears to the shaft arrangement to selectively provide four gear ratios between the input and output shafts.

### CROSS-REFERENCE TO RELATED APPLICATION

This application claims the benefit of and priority to U.S. Provisional Application Ser. No. 63/256,702, filed Oct. 18, 2021, the disclosure of which is hereby incorporated by reference in its entirety.

### BACKGROUND OF THE INVENTION

There is a trend in the electric vehicle market of moving to higher speed electric motors (EM), which require deeper gear ratios of the transmission in order to provide satisfactory torque and speed at the vehicle wheels.

When the transmission is integrated into a bevel gearing differential axle, one of the challenges is the unsprang mass of a motor and transmission attached to the differential axle. In this case, a high-power density, short, and lightweight transmission is desirable. There is therefore a need in the art for a transmission that is compact and can operate with various electric motors such as low-speed electric motors operating around 3,500 rpm and high-speed electric motors operating around 8,000 rpm. These electric motors may be used on commercial vehicle application (trucks and buses). In these kinds of application, multi-speed transmissions may provide benefits over direct drive (motor w/o transmission), as they can provide high torque to move a fully loaded truck at a grade, and at high road speed.

### SUMMARY

A transmission can include a shaft arrangement including an input shaft configured to couple to a primer mover and an output shaft coaxially aligned with the input shaft; a plurality of drive gears supported by the shaft arrangement and including a first drive gear, a second drive gear, and a third drive gear; a countershaft arrangement including a first countershaft and a second countershaft supporting a plurality of pinion gears intermeshed with the first, second, and third drive gears; a clutch arrangement including a first clutch assembly and a second clutch assembly operable to lock the first, second, and third drive gears to the shaft arrangement to selectively provide four gear ratios between the input and output shafts.

In some examples, the first clutch assembly is operable between: a neutral position in which the first and second drive gears are rotatable with respect to the input shaft; a first position in which the first drive gear is locked to the input shaft and the second drive gear is rotatable with respect to the input shaft; and a second position in which the first drive gear is rotatable with respect to the input shaft and the second drive gear is locked to the input shaft.

In some examples, the second clutch assembly is operable between: a neutral position in which the second and third drive gears are rotatable with respect to the output shaft; a first position in which the second drive gear is locked to the output shaft and the third drive gear is rotatable with respect to the output shaft; and a second position in which the second drive gear is rotatable with respect to the output shaft and the third drive gear is locked to the output shaft.

In some examples, the transmission is operable between: a first gear ratio in which the first clutch assembly is in the first position and the second clutch assembly is in the second position; a second gear ratio in which the first clutch assembly is in the second position and the second clutch assembly is in the second position; a third gear ratio in which the first clutch assembly is in the first position and the second clutch assembly is in the first position; and a fourth gear ratio in which the first clutch assembly is in the second position and the second clutch assembly is in the first position.

In some examples, one or both of the first and second clutch assemblies are mechanically operated clutch assemblies.

In some examples, one or both of the first and second clutch assemblies are electrically operated clutch assemblies.

A drivetrain assembly can include an electric motor having an output shaft; a transmission assembly operably connected to the electric motor, the transmission assembly including: a shaft arrangement including an input shaft coupled to the electric motor output shaft and including an output shaft coaxially aligned with the input shaft; a plurality of drive gears supported by the shaft arrangement and including a first drive gear, a second drive gear, and a third drive gear; a countershaft arrangement including a first countershaft and a second countershaft supporting a plurality of pinion gears intermeshed with the first, second, and third drive gears; a clutch arrangement including a first clutch assembly and a second clutch assembly operable to lock the first, second, and third drive gears to the shaft arrangement to selectively provide four gear ratios between the input and output shafts.

A transmission can include a housing; a shaft arrangement disposed within the housing and including an input shaft configured to couple to a prime mover and an output shaft coaxially aligned with the input shaft; a plurality of drive gears disposed within the housing and supported by the shaft arrangement and including a first drive gear, a second drive gear, and a third drive gear; a countershaft arrangement supporting a plurality of pinion gears intermeshed with the first, second, and third drive gears; and a clutch arrangement disposed within the housing and including a first clutch assembly and a second clutch assembly operable to lock the first, second, and third drive gears to the shaft arrangement to selectively provide four gear ratios between the input and output shafts.

In some examples of the above aspect, the housing includes a first cover at one end thereof and a second cover at an opposing end thereof, the first and second covers enclosing the gear mechanism and the plurality of shafts. In other examples, the actuation mechanism includes a front actuator coupled to a front linkage, a rear actuator coupled to a rear linkage, and a clutch assembly, wherein the front actuator and rear actuator are configured to move the clutch assembly via the front linkage and the rear linkage, respectively. For example, the input shaft includes a gear supported thereon. In other examples, the input shaft and the output shaft are supported by bearings in the housing. In another example, the bearings include one of tapered roller bearings, needle bearings, and axial bearings. In yet another example, a first countershaft of the plurality of shafts and a second countershaft of the plurality of shafts are parallel to the input shaft and to the output shaft. For example, the first countershaft and the second countershaft are supported by bearings in the housing. In other examples, the input shaft is configured to transfer the power to the transmission, the power being evenly distributed to the first countershaft and the second countershaft.

In other examples of the above aspect, the transmission further includes a mesh gear train configured to enable four selectable ratios from the electric machine to the differential mechanism. In yet other examples, the first and second countershafts are configured to support at least one of first pinion gears meshed with a first drive gear supported by the input shaft, second pinion gears meshed with a second drive gear supported by the input shaft, and third pinion gears meshed with a third drive gear supported by the input shaft. In an example, the transmission further includes a shifting mechanism configured to selectively engage the first pinion gears, the second pinion gears, and the third pinion gears, the shifting mechanism including the actuation mechanism. In another example, the input shaft includes a plurality of first grooves, and the shifting mechanism includes a first linkage assembly having a plurality of first shift linkages in the plurality of first grooves formed and within an internal circumference of the first drive gear.

In other examples, the plurality of first shift linkages are coupled at a first end thereof

to a first sliding dog clutch, and at a second end thereof to a first sliding sleeve, the first sliding sleeve including a lip protruding therefrom and configured to prevent pressing the plurality of first shift linkages against the input shaft. In further examples, the output shaft includes a plurality of second grooves, and the shifting mechanism includes a second linkage assembly having a plurality of second shift linkages in the plurality of second grooves formed and within an internal circumference of the third drive gear. For example, the plurality of second shift linkages are coupled at a first end thereof to a second sliding dog clutch, and at a second end thereof to a second sliding sleeve, the second sliding sleeve including notches formed thereon. In other examples, the front actuator includes a first shift fork that includes a first pivot, the first shift fork being configured to move about the first pivot upon linear movement of the front actuator to move the first sliding sleeve axially, and the rear actuator includes a shift linkage coupled to a second shift fork that includes a second pivot, the second shift fork being configured to move about the second pivot upon linear movement of the rear actuator to move the second sliding sleeve axially.

In further examples of the above aspect, axial movement of the first sliding sleeve and the second sliding sleeve urge the first and second shift linkages and move the first and second sliding dog clutches axially to connect to one of the first pinion gears, the second pinion gears, and the third pinion gears. In another example, a gear ratio of the output shaft to the input shaft is one of 9.88 to 1, 4.74 to 1, 2.08 to 1, and 1 to 1.

### BRIEF DESCRIPTION OF THE DRAWINGS

FIG. 1 is a front perspective view of a transmission, according to various examples of the disclosure.

FIG. 2 is a rear perspective view of a transmission, according to various examples of the disclosure.

FIG. 3 is a front perspective view of a transmission showing an actuator, according to various examples of the disclosure.

FIG. 4 is a rear perspective view of a transmission showing an actuator, according to various examples of the disclosure.

FIG. 5 is a partial schematic view of a gear arrangement of the transmission, according to various examples of the disclosure.

FIG. 6 is a partial sectional view of a gear arrangement of the transmission, according to various examples of the disclosure.

FIG. 7 is a partial sectional view of a gear arrangement and clutch of the transmission, according to various examples of the disclosure.

FIG. 8 is a partial sectional view of a transmission showing bearings, according to various examples of the disclosure.

FIG. 9 is a partial exploded perspective view of a first shift linkage assembly, according to various examples of the disclosure.

FIG. 10 is a partial perspective view of a first shift linkage assembly, according to various examples of the disclosure.

FIG. 11 is a partial exploded perspective view of a second shift linkage assembly, according to various examples of the disclosure.

FIG. 12 is a partial perspective view of a second shift linkage assembly, according to various examples of the disclosure.

FIG. 13 is a partial schematic sectional view of a gear arrangement detailing a power path when in a first gear, according to various examples of the disclosure.

FIG. 14 is a partial schematic sectional view of a gear arrangement detailing the power path when in a second gear, according to various examples of the disclosure.

FIG. 15 is a partial schematic sectional view of a gear arrangement detailing the power path when in a third gear, according to various examples of the disclosure.

FIG. 16 is a partial schematic sectional view of a gear arrangement detailing the power path when in a fourth gear, according to various examples of the disclosure.

FIG. 17 is a schematic representation of a transmission attached to a bevel gearing differential.

FIG. 18 is a schematic view of a gear arrangement detailing a power path when in a first gear, according to various examples of the disclosure.

FIG. 19 is a schematic view of a gear arrangement detailing the power path when in a second gear, according to various examples of the disclosure.

FIG. 20 is a schematic view of a gear arrangement detailing the power path when in a third gear, according to various examples of the disclosure.

FIG. 21 is a schematic view of a gear arrangement detailing the power path when in a fourth gear, according to various examples of the disclosure.

### DETAILED DESCRIPTION

Various examples of the disclosure address advantages linked to power dense, multiple speed, highly integrated, electric vehicle solutions. For example, twin countershafts may allow for each gear stage to handle large loads, while a shift mechanism may allow the gear stages to be placed very close together, e.g., substantially closer than conventional gear stages. In other examples, the concentric positioning of the various gears and shafts may allow for the transmission to be closely integrated with the electric machine.

Various examples of the disclosure include an ultra-compact, high power density (e.g., up to 50 kW/L) four-speed electric vehicle (EV) transmission utilizing twin counter shafts, three sets of gears, and an innovative shifting mechanism. For example, the shifting mechanism may reduce or virtually eliminate the space between gear sets that is typically required for shift forks, resulting in a smaller overall package. The gear architecture of various examples is designed to be concentric where, e.g., the input shaft is in line with, or co-axial with, the output shaft.

In various examples, when the transmission is integrated into a bevel gearing differential axle, one of the challenges is the unsprang mass of motor and transmission attached to the differential axle. In this case, a high-power density, short, and lightweight transmission may be advantageous. Examples of the four-speed transmission according to this disclosure addresses these challenges. For example, the transmission may weigh, e.g., 35 kg and may have a total length of, e.g., 260 mm.

In various examples, the transmission according to this disclosure may be installed on a vehicle as a central drive configuration connecting to the rear axle through an output flange and propeller shaft. In this example, the ultra-compact transmission may allow for shorter propeller shafts leaving more room for the battery package.

As there is a trend in the EV market of moving to higher speed electric motors (EM), which typically require deeper gear ratios of the transmission in order to provide satisfactory torque and speed at the vehicle wheels, the transmission according to examples of the disclosure has a 9.88 to 1 overall ratio which pairs fittingly with both low-speed EMs, e.g., 3,500 rpm, and high-speed EMs, e.g., 8,000 rpm.

Examples of the architecture of the transmission include a twin-countershaft, three-gear layer arrangement. In an example, the power generated from the electric machine enters the system through an input shaft, and this input power is then distributed evenly to the twin countershafts. For example, the input power is distributed evenly to the twin countershafts either through the layer-one or layer-two pinion, depending on the selected speed. In an example, power then leaves the system through the output shaft, which can then be passed to an external final axle gear ratio and differential.

When in first speed mode, the power enters the system through the layer-one drive pinion, then is sent to and distributed evenly between the two countershafts, and is subsequently passed to the layer-three driven gear and out of the system.

When in second speed mode, the power enters the system through the layer-two drive pinion, then is sent to and distributed evenly to the two countershafts and is subsequently passed to the layer-three driven gear and out of the system.

When in third speed mode, the power enters the system through the layer-one drive pinion, then is sent to and distributed evenly to the two countershafts and is subsequently passed to the layer-two driven pinion (previously used as the drive pinion in second speed mode) and out of the system.

When in fourth speed mode, the input shaft and output shaft are directly coupled through the clutch architecture, bypassing all gears.

In various examples, the shifting mechanism is formed of, or includes, two similar shifting linkages, one shifting linkage at the front of the transmission which selects if layer-one or layer-two gearsets are to be locked to the input shaft, and a second shifting linkage at the rear of the transmission that selects if layer-two or layer-three is to be locked to the output shafts. Each set of three shifting linkages may run below the gearsets and are connected to a dog clutch via a special internal feature of the dog clutch. The other end of the shifting linkages may be connected to a special, lightweight sliding sleeve. Electric actuators positioned externally on the transmission enclosure and connected to switch lever arms and shifting forks may move the sliding sleeves axially, which pull and push the shifting linkages, and ultimately the dog clutch axially to connect to one gear or the other.

In various examples, the four-speed transmission according to various examples may be installed on a vehicle as a central drive configuration connecting to the rear axle through an output flange and propeller shaft. In this example, the novel ultra-compact transmission may allow for shorter propeller shafts, thus leaving more room for the battery package. In another aspect, the transmission can also be integrated to the differential rear axle.

In that case, the output flange is removed and the output shaft connects directly to the differential pinion gear. Also, the transmission housing may be modified to be bolted to the differential enclosure.

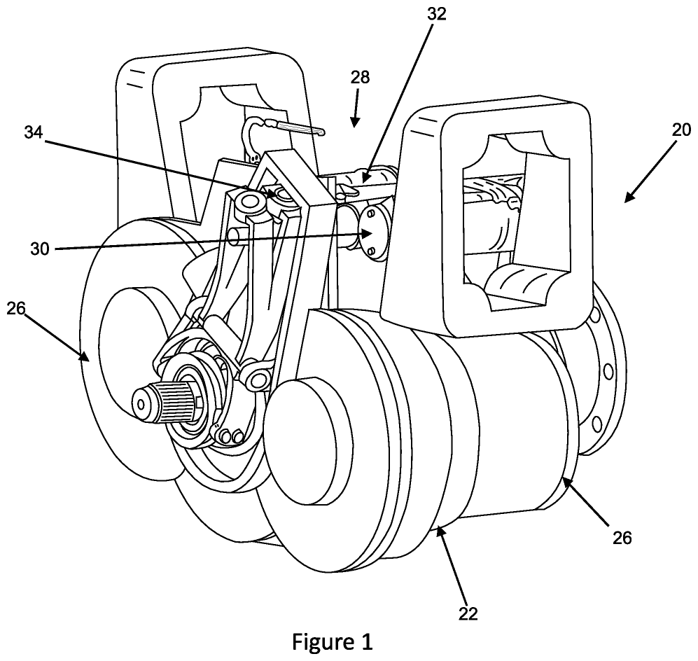

FIGS. 1-4 are various perspective views of a transmission, according to various examples of the disclosure. In various examples, there is shown a transmission 20. The transmission 20 may also be referred to as a gear box. The transmission 20 includes a housing 22 that receives a gear mechanism 24 and shafts of the transmission 20. The housing 22 has covers 26 on opposing ends that enclose the gear mechanism and shafts.

Attached on an exterior of the housing 22 is an actuation mechanism 28 that includes front and rear actuators 30, 32 coupled to front and rear linkages 34, 36 that move a clutch assembly to determine various gears, as will be discussed in more detail below.

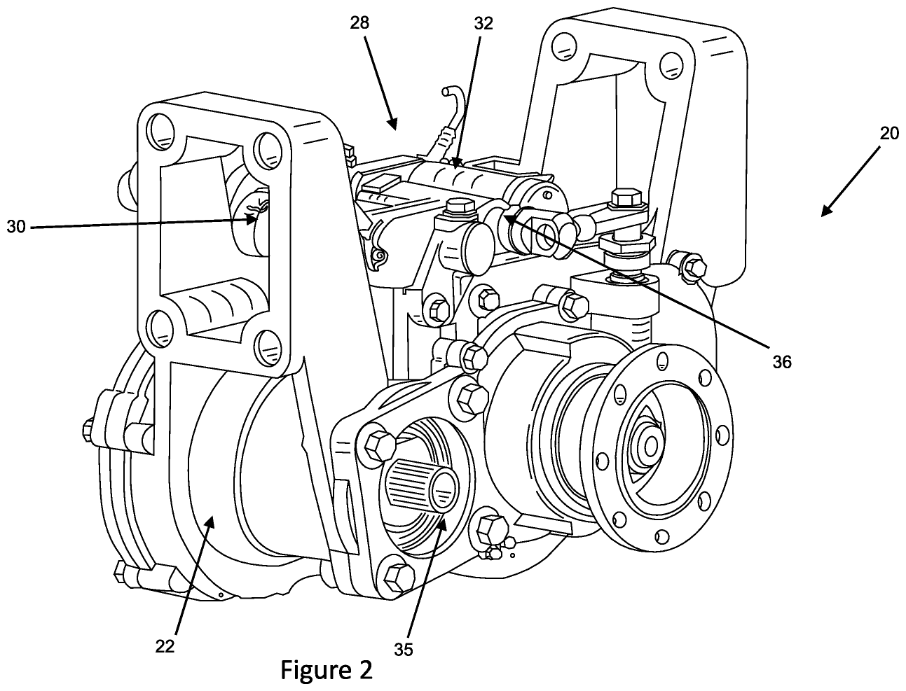

Referring to FIG. 2, the transmission 20 may include a power take-off (PTO) generator mounting area 35 to allow for a two-speed generator function.

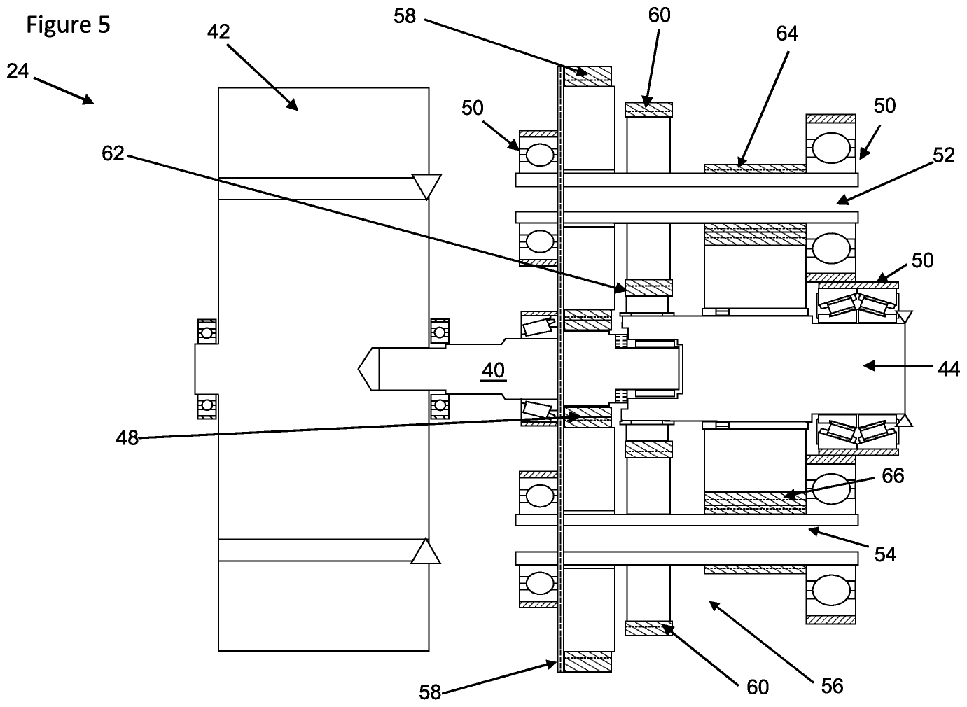

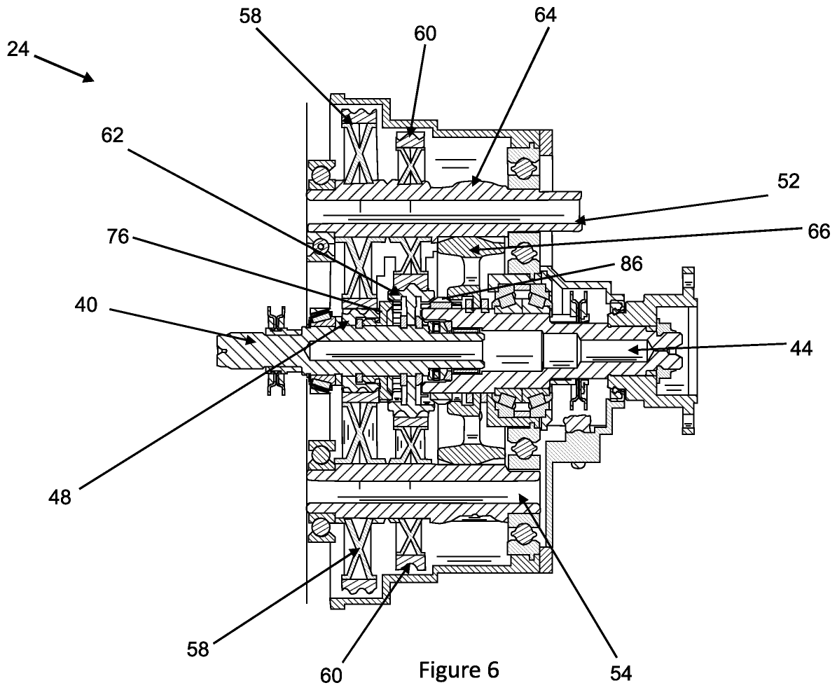

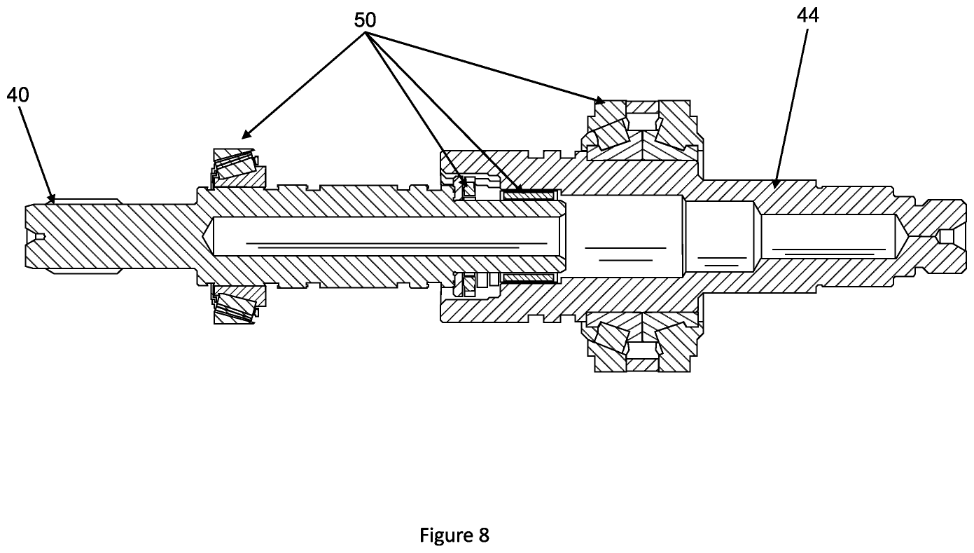

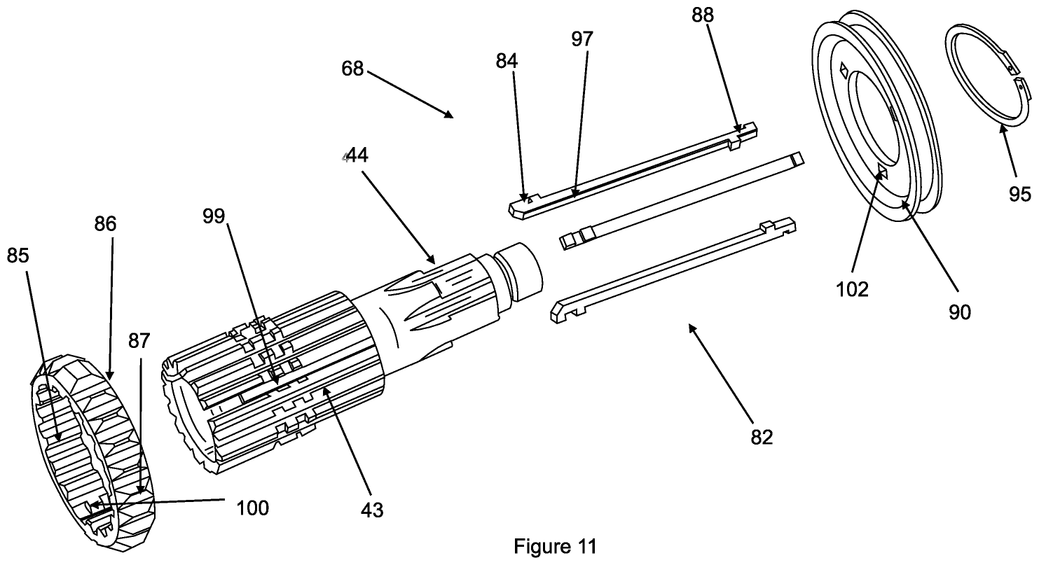

Referring to FIGS. 5-7, the transmission 20 includes an input shaft 40 that is coupled to an electric machine 42 to provide power input. An output shaft 44 is selectively coupled to the input shaft 40 and transfers power to a differential mechanism 46 (FIG. 11). The input shaft 40 includes a first drive gear 48 supported thereon. The input and output shafts 40, 44 are supported by bearings 50 in the housing 22, best seen in FIG. 8. Various types of bearings may be utilized, including tapered roller bearings, needle bearings, and axial bearings.

First and second counter shafts 52, 54 are positioned parallel to the input and output shafts 40, 44. The first and second counter shafts 52, 54 are supported by bearings 50 in the housing 22. The power generated from the electric machine 42 enters the transmission 20 through the input shaft 40. The input power is then distributed evenly to the first and second countershafts 52, 54, as will be discussed in more detail below.

The transmission 20 includes a constant mesh gear train 56 that enables four different selectable ratios from the electric machine 42 to the differential 46. The four-stage gear train 56 includes first and second counter shafts 52, 54 positioned parallel to the input and output shafts 40, 44. The first and second counter shafts 52, 54 support first pinion gears 58 meshed with the first drive gear 48 supported by the input shaft 40.

The first and second counter shafts 52, 54 also support second pinion gears 60. The second pinion gears 60 are meshed with a second drive or driven gear 62 that is supported by the output shaft 44.

The first and second counter shafts 52, 54 also support third pinion gears 64. The third pinion gears 64 are meshed with a third drive gear 66 that is supported by the output shaft 44.

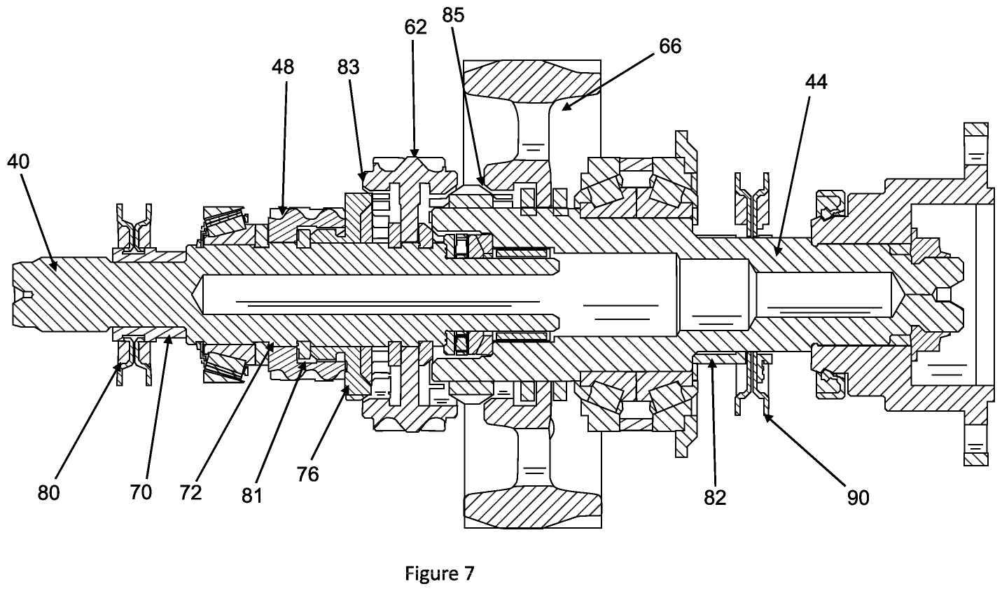

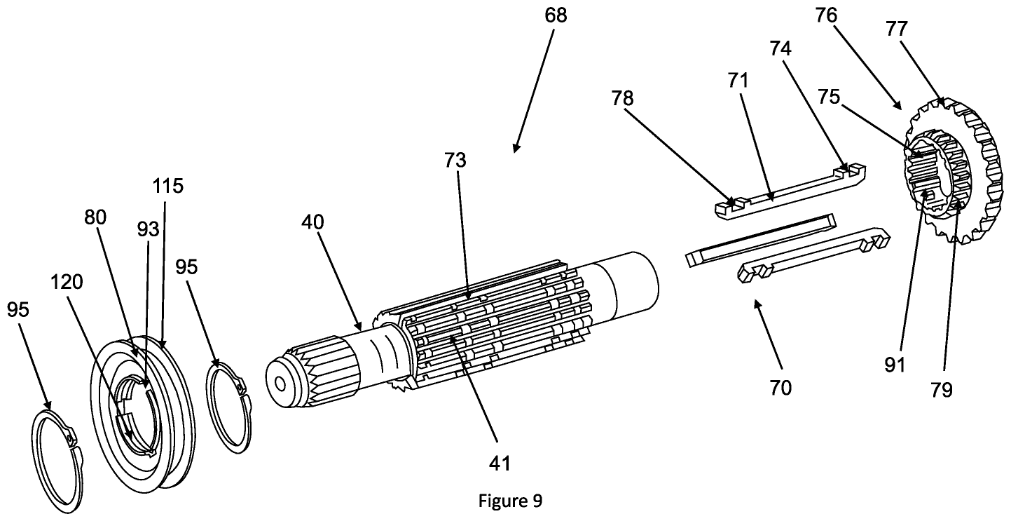

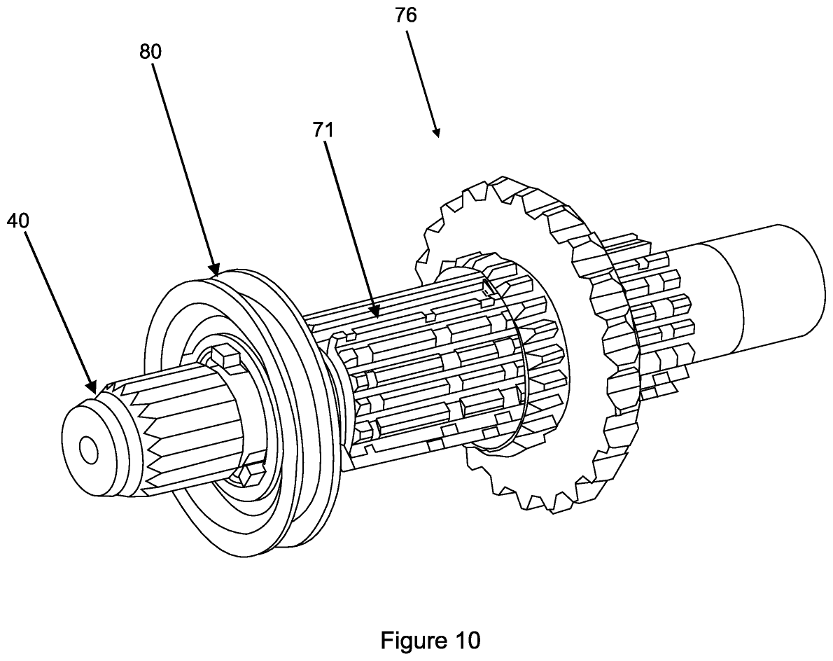

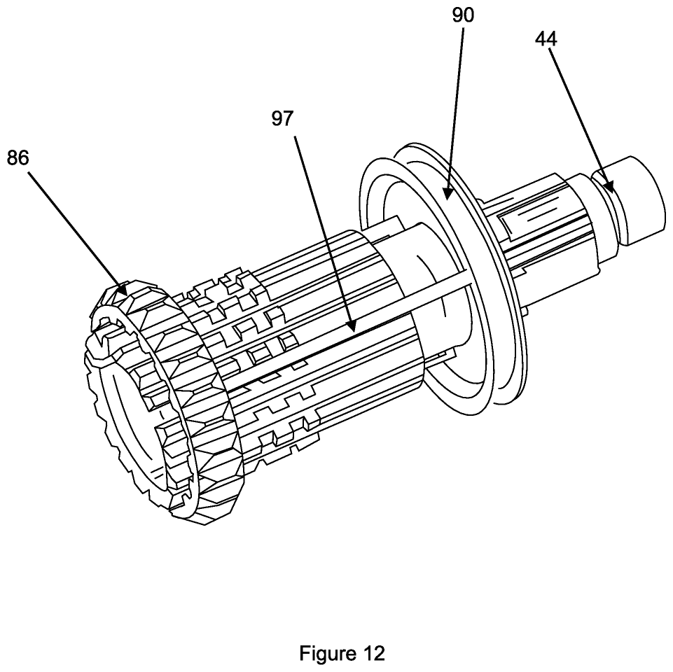

Referring to FIGS. 7 and 9-12, the transmission 20 includes a shifting mechanism 68 to selectively engage various gears to define a four-speed transmission. The shifting mechanism 68 includes the actuation mechanism 28 that includes front and rear actuators 30, 32 coupled to front and rear linkages 34, 36 that move sliding dog clutches 76, 86.

The gear mechanism 24 include gears 48, 62, and 66 that are free to spin over the input and output shafts 40, 44. There are splines 41 formed on the input shaft 40, and splines 43 formed on the output shaft 44. The sliding dog clutches 76 and 86 have internal splines 75, 85 formed thereon and are connected to the input shaft 40 and output shaft 44, respectively, through those splines 75, 85. Once the dog clutches 76, 86 are shifted axially toward one of the gears 48, 62, 66, external splines 77, 79, 87 of the sliding dog clutches 76, 86 engage to the internal clutch splines 81, 83, 85, best seen in FIG. 7, of the gears 48, 62, and 66 respectively, then the torque is transferred from the input shaft 40 to the designated gear through the sliding dog clutch 76, 86 as will be discussed in more detail below.

The shifting mechanism 68 includes a first shift linkage assembly 70 that includes three shift linkages 71 that are positioned in grooves 73 formed in the input shaft 40 and within an internal circumference 72 of the first drive gear 48. This configuration reduces a space between gear layers. The shift linkages 71 are coupled on a first end 74 to a post 91 formed on the sliding dog clutch 76. A second end 78 of the linkages 71 is connected to a first sliding sleeve 80. The first sliding sleeve includes two stamped halves 115 that could be either riveted or welded together. This construction provides for compactness, lightweight, and low cost. A similar structure is shown in a second sliding sleeve 90.

First sliding sleeve 80 includes a lip 120 protruding out of the internal diameter. The lip 120 on both sides of the sliding sleeve 80 prevents retaining rings 95 from pressing the shift linkages 71 against the input shaft 40, which could cause friction resulting in hard shift and wear. In such a design, the retaining rings 95 sit on the sliding sleeve lip 120 and no radial force acts on the shift linkages 71.

The sliding sleeve 80 includes notches 93 formed thereon that receive the second end 78. Retaining rings 95 maintain the second end 78 in the notches 93.

The shifting mechanism 68 includes a second shift linkage assembly 82 that includes three shift linkages 97 that are positioned in grooves 99 formed in the output shaft 44 and within an internal circumference of the third drive gears 66. This configuration reduces a space between gear layers. The shift linkages 97 are coupled on a first end 84 to a post 100 formed on the sliding dog clutch 86. The second end 88 of the shift linkages 97 are connected to the second sliding sleeve 90. The sliding sleeve 90 includes notches 102 formed thereon that receive the second end 88. Retaining ring 95 maintains the second end 88 in the notches 102.

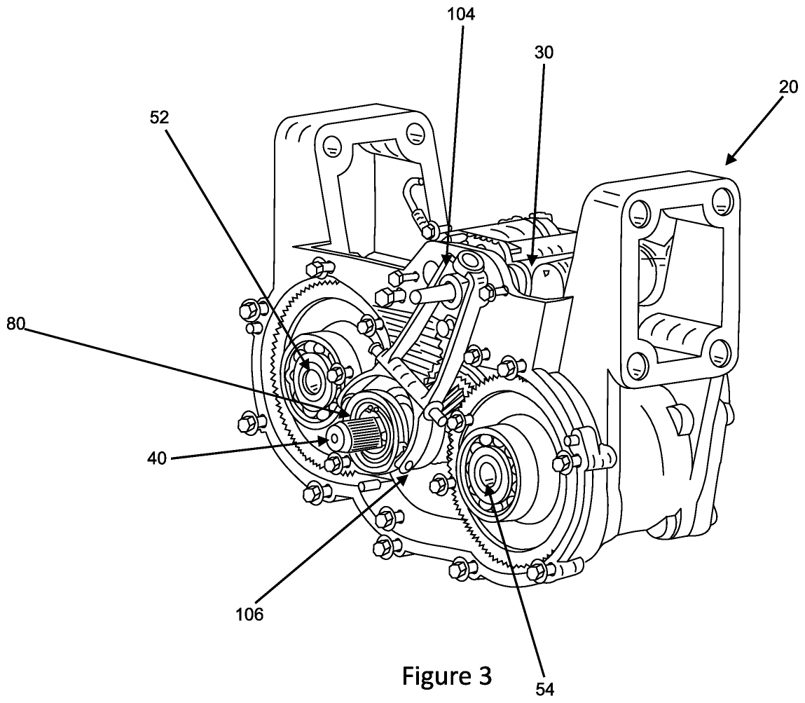

Referring to FIGS. 1 and 3, the actuation mechanism 28 includes front and rear actuators 30, 32 coupled to front and rear linkages 34, 36 positioned externally on the transmission housing 22. In the example shown, actuators 30, 32 are electrically powered and controlled actuators such that an electrical input to the actuators 30, 32 causes the actuators 30, 32 to energize to selectively move the dog clutches 76, 86 in opposite first and second directions between respective first and second positions. In the example shown, the actuators 30, 32 are linear electric actuators. The actuators 30, 32 can also be powered to position the dog clutches 76, 86 into a neutral position between the first and second positions such that the dog clutches 76, 86 are not in engagement with any of the drive gears 48, 62, 66. The actuators 30, 32 can be configured to directly control the position of the dog clutches 76, 86 or can be configured to control the position of the dog clutches 76, 86 indirectly through linkage mechanisms, for example linkage mechanisms of the type described below. In some examples, the actuators 30, 32 can be provided within the housing 22 instead of externally.

Referring to FIGS. 1 and 3, the front actuator 30 includes a shift fork 104 that has a pivot 106. Linear movement of the actuator 30 causes the shift fork 104 to move about the pivot 106 and move the first sliding sleeve 80 axially.

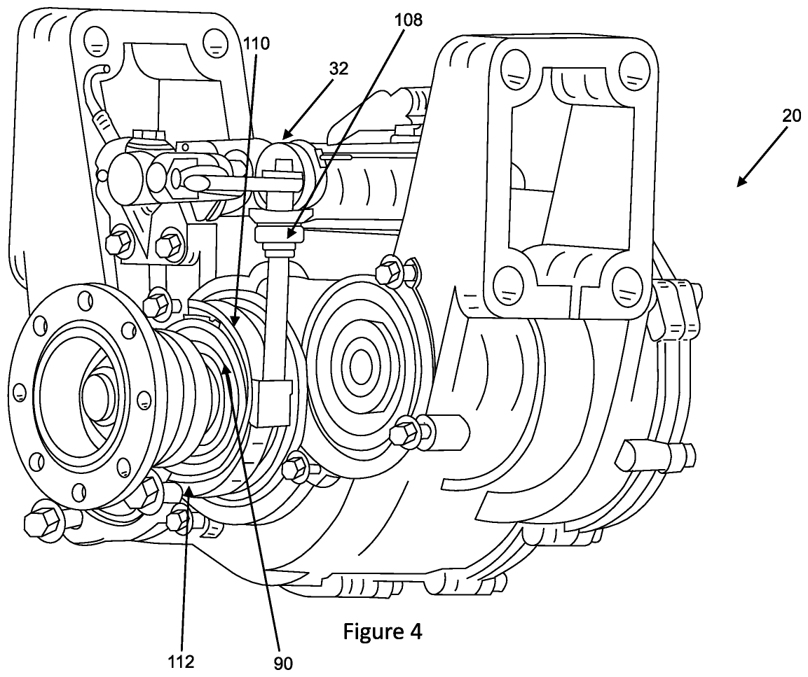

Referring to FIGS. 2 and 4, the rear actuator 32 includes a shift linkage 108 that is coupled to a shift fork 110 that has a pivot 112. Linear movement of the actuator 32 causes the shift linkage 108 to rotate and move the shift fork 110 about the pivot 112 and move the second sliding sleeve 90 axially. Axial movement of the sliding sleeves 80, 90 pulls and pushes the shift linkages 71, 97, which in turn moves the sliding dog clutches 76, 86 axially to connect to one of the gears.

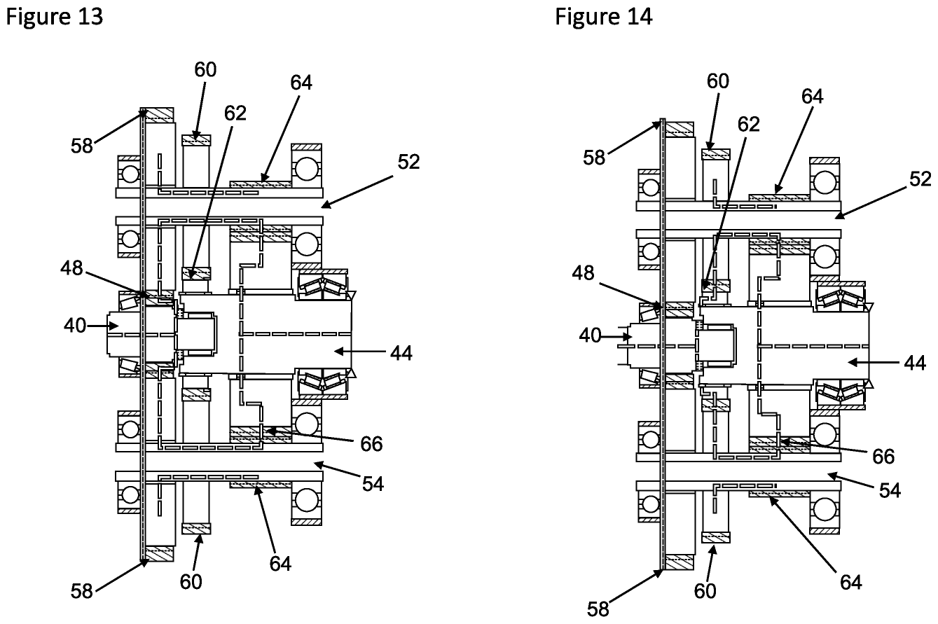

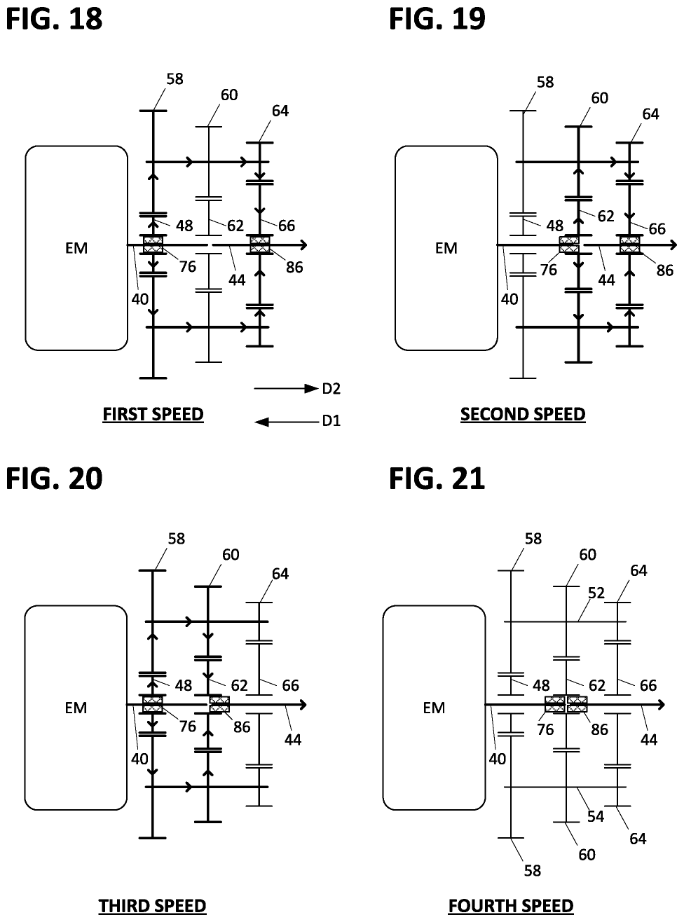

Referring to FIGS. 13 and 18, when in first speed, the power enters the transmission 20 through the first driven gear 48 and to the first pinion gear 58, then is distributed evenly to the first and second countershafts 52, 54 and is then passed through the third pinion gear 64 to the third driven gear 66 and out of the transmission. To achieve the first speed, the actuator assembly 30 is energized to cause the first dog clutch 76 move axially in the direction D1 and into the first position while the actuator assembly 32 is energized to cause the second dog clutch 86 to move axially in the direction D2 and into the second position. With respect to the first dog clutch 76, this action causes the externally facing splines 79 to engage with internally facing splines 81 of the first drive gear 48 such that the first drive gear 48 is grounded to the input shaft 40. With respect to the second dog clutch 86, this action causes the externally facing splines 87 to engage with the internally facing splines 85 of the third drive gear 66 such that the third drive gear 66 is grounded to the output shaft 44. In one aspect, the gear ratio may be 9.88 to 1.

Referring to FIGS. 14 and 19, when in second speed, the power enters the transmission 20 through the gear mechanism 24, and in particular through the second drive gear 62 and then to the second pinion gear 60, then is distributed evenly to the first and second countershafts 52, 54 and is then passed through the third pinion gear 64 to the third driven gear 66 and out of the transmission. To achieve the second speed, the actuator assembly 30 is energized to cause the first dog clutch 76 to move axially in the direction D2 and into the second position while the actuator assembly 32 is energized to cause the second dog clutch 86 to move axially in the direction D2 and into the second position (or to continue to hold the second dog clutch 86 in the second position if already there). With respect to the first dog clutch 76, this action causes the externally facing splines 77 to engage with the internally facing splines 83 of the second drive gear 62 such that the second drive gear 62 is grounded to the input shaft 40. With respect to the second dog clutch 86, this action is the same as already described above with respect to the first gear. In one aspect, the gear ratio may be 4.74 to 1.

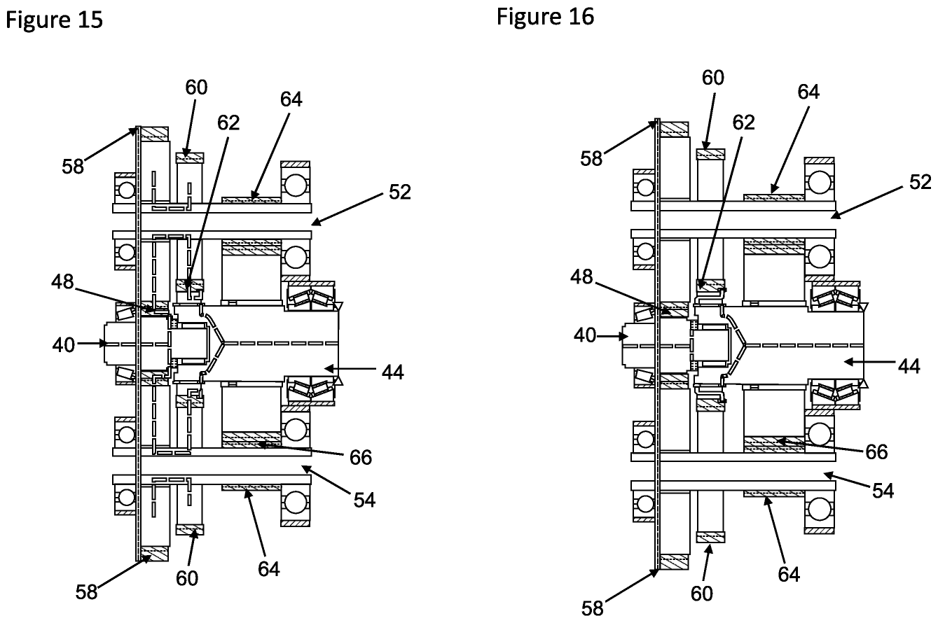

Referring to FIGS. 15 and 20, when in third speed, the power enters the transmission 20 through first driven gear 48 and to the first pinion gear 58, then is distributed evenly to the two countershafts 52, 54 and is then passed through the second pinion gear 60 to the second driven gear 62 and out of the transmission. To achieve the third speed, the actuator assembly 30 is energized to cause the first dog clutch 76 to move axially in the direction D1 and into the first position while the actuator assembly 32 is energized to cause the second dog clutch 86 to move axially in the direction D1 and into the first position. With respect to the first dog clutch 76, this action is the same as already described with respect to the first speed. With respect to the second dog clutch 86, this action causes the externally facing splines 87 to engage with the internally facing splines 83 of the second drive gear 62 such that the second drive gear 62 is grounded to the output shaft 44. In one aspect, the gear ratio may be 2.08 to 1.

Referring to FIGS. 16 and 21, when in fourth speed, the input shaft 40 and output shaft 44 are directly coupled, bypassing all gears. To achieve the fourth speed, the actuator assembly 30 is energized to cause the first dog clutch 76 to move axially in the direction D2 and into the second position while the actuator assembly 32 is energized to cause the second dog clutch 86 to move axially in the direction D1 and into the first position (or to continue to hold the second dog clutch 86 in the first position if already there). With respect to the first dog clutch 76, this action is the same as already described with respect to the second speed. With respect to the second dog clutch 86, this action is the same as already described with respect to the third speed. In one aspect, the gear ratio may be 1 to 1.

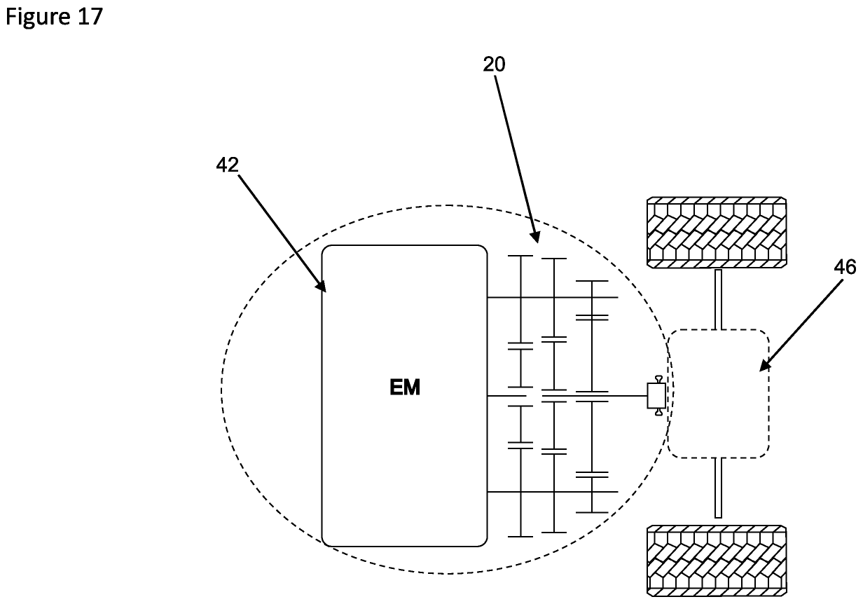

Referring to FIG. 17, the transmission 20 can be installed on a vehicle as an assembly that is attached to the bevel gear differential 46. The transmission 20 provides a compact structure allowing selection of four speeds.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some examples, some one or more of the most important method steps may be executed by such an apparatus.

Generally, examples of the present disclosure can be implemented through the use of computer program products with program codes, the program codes being operative for performing the operations described herein when the computer program product runs on a computer such as may be used to embody any or all of controllers 130, 82, 92, 96, 107, or 127, etc.

With respect to the above gear speeds, it is noted that since the PTO output at 35 is defined by the rotational speed of the countershaft 64, the first dog clutch 76 can be moved to achieve different PTO output speeds. For example, in the first position of the first dog clutch 76, a first or low PTO speed is achieved which is, in the arrangement shown, approximately half the speed of the motor. When the first dog clutch 76 is moved into the second position, a second or high PTO speed is achieved which is approximately same speed of motor. Accordingly, the disclosed configuration additionally provides for two-speed PTO take-off operation.

Although various examples and examples are described herein, those of ordinary skill in the art will understand that many modifications may be made thereto within the scope of the present disclosure. Accordingly, it is not intended that the scope of the disclosure in any way be limited by the examples provided.

1-43. (canceled)

44. A transmission comprising:
a) a shaft arrangement including an input shaft configured to couple to a prime mover and an output shaft coaxially aligned with the input shaft;
b) a plurality of drive gears supported by the shaft arrangement and including a first drive gear, a second drive gear, and a third drive gear;
c) a countershaft arrangement including a first countershaft and a second countershaft supporting a plurality of pinion gears intermeshed with the first, second, and third drive gears; and
d) a clutch arrangement including a first clutch assembly and a second clutch assembly operable to lock the first, second, and third drive gears to the shaft arrangement to selectively provide four gear ratios between the input and output shafts.

45. The transmission of claim 44, wherein;
the first clutch assembly is operable between:
a) a neutral position in which the first and second drive gears are rotatable with respect to the input shaft;
b) a first position in which the first drive gear is locked to the input shaft and the second drive gear is rotatable with respect to the input shaft; and
c) a second position in which the first drive gear is rotatable with respect to the input shaft and the second drive gear is locked to the input shaft;
wherein the second clutch assembly is operable between:
d) a neutral position in which the second and third drive gears are rotatable with respect to the output shaft;
e) a first position in which the second drive gear is locked to the output shaft and the third drive gear is rotatable with respect to the output shaft; and
f) a second position in which the second drive gear is rotatable with respect to the output shaft and the third drive gear is locked to the output shaft.

46. The transmission of claim 45, wherein the transmission is operable between:
a) a first gear ratio in which the first clutch assembly is in the first position and the second clutch assembly is in the second position;
b) a second gear ratio in which the first clutch assembly is in the second position and the second clutch assembly is in the second position;
c) a third gear ratio in which the first clutch assembly is in the first position and the second clutch assembly is in the first position; and
d) a fourth gear ratio in which the first clutch assembly is in the second position and the second clutch assembly is in the first position.

47. The transmission of claim 44, wherein the first clutch assembly includes a first dog clutch and a first electric actuator controlling a position of the first dog clutch.

48. The transmission of claim 47, wherein the first electric actuator is operatively connected to the first dog clutch by a first mechanical linkage.

49. The transmission of claim 47, wherein the second clutch assembly includes a second dog clutch and a second electric actuator controlling a position of the second dog clutch.

50. The transmission of claim 49, wherein the second electric actuator is operatively connected to the second dog clutch by a second mechanical linkage and wherein the first electric actuator is operatively connected to the first dog clutch by a first mechanical linkage.

51. The transmission of claim 49, wherein one or both the first and second electrical actuators is located on the exterior of a housing enclosing the shaft arrangement, the plurality of drive gears, the countershaft arrangement, and the clutch arrangement.

52. The transmission of claim 44, further comprising:
a) a power take-off location driven by the first or second countershaft.

53. A transmission comprising:
a) a housing;
b) a shaft arrangement disposed within the housing and including an input shaft configured to couple to a prime mover and an output shaft coaxially aligned with the input shaft;
c) a plurality of drive gears disposed within the housing and supported by the shaft arrangement and including a first drive gear, a second drive gear, and a third drive gear;
d) a countershaft arrangement supporting a plurality of pinion gears intermeshed with the first, second, and third drive gears; and
e) a clutch arrangement disposed within the housing and including a first clutch assembly and a second clutch assembly operable to lock the first, second, and third drive gears to the shaft arrangement to selectively provide four gear ratios between the input and output shafts.

54. The transmission of claim 53, wherein the clutch arrangement includes an actuation mechanism, the actuation mechanism comprising:
a) a front actuator coupled to a front linkage;
b) a rear actuator coupled to a rear linkage; and
c) a clutch assembly;
d) wherein the front actuator and the rear actuator are configured to move the clutch arrangement via the front linkage and the rear linkage, respectively.

55. The transmission of claim 53, wherein:
a) the input shaft comprises a plurality of first grooves; and
b) the clutch arrangement comprises a first linkage assembly having a plurality of first shift linkages in the plurality of first grooves formed and within an internal circumference of the first drive gear.

56. The transmission of claim 55, wherein:
a) the plurality of first shift linkages are coupled at a first end thereof to a first sliding dog clutch of the first clutch assembly, and at a second end thereof to a first sliding sleeve;
b) the first sliding sleeve comprising a lip protruding therefrom and configured to prevent the plurality of first shift linkages from being pressed against the input shaft.

57. The transmission of claim 56, wherein:
a) the output shaft comprises a plurality of second grooves; and
b) the clutch arrangement comprises a second linkage assembly having a plurality of second shift linkages in the plurality of second grooves formed and within an internal circumference of the third drive gear.

58. The transmission of claim 57, wherein the plurality of second shift linkages are coupled at a first end thereof to a second dog clutch assembly, and at a second end thereof to a second sliding sleeve, the second sliding sleeve comprising notches formed thereon.

59. The transmission of claim 58, wherein:
a) the front actuator comprises a first shift fork that comprises a first pivot, the first shift fork being configured to move about the first pivot upon linear movement of the front actuator to move the first sliding sleeve axially; and
b) the rear actuator comprises a shift linkage coupled to a second shift fork that comprises a second pivot, the second shift fork being configured to move about the second pivot upon linear movement of the rear actuator to move the second sliding sleeve axially.

60. The transmission of claim 59, wherein axial movement of the first sliding sleeve and the second sliding sleeve urge the first and second shift linkages and move the first and second dog clutches axially to connect to one of the plurality of pinion gears.

61. A drivetrain assembly comprising:
a) an electric motor having an output shaft; and
b) a transmission assembly operably connected to the electric motor, the transmission assembly including:
i. a shaft arrangement including an input shaft coupled to the electric motor output shaft and including an output shaft coaxially aligned with the input shaft;
ii. a plurality of drive gears supported by the shaft arrangement and including a first drive gear, a second drive gear, and a third drive gear;
iii. a countershaft arrangement including a first countershaft and a second countershaft supporting a plurality of pinion gears intermeshed with the first, second, and third drive gears; and
iv. a clutch arrangement including a first clutch assembly and a second clutch assembly operable to lock the first, second, and third drive gears to the shaft arrangement to selectively provide four gear ratios between the input and output shafts.

62. The drivetrain assembly of claim 61, wherein the first clutch assembly includes a first dog clutch and a first electric actuator controlling a position of the first dog clutch, wherein the first electric actuator is operatively connected to the first dog clutch by a first mechanical linkage, wherein the second clutch assembly includes a second dog clutch and a second electric actuator controlling a position of the second dog clutch, and wherein the second electric actuator is operatively connected to the second dog clutch by a second mechanical linkage and wherein the first electric actuator is operatively connected to the first dog clutch by a first mechanical linkage.

63. The drivetrain assembly of claims 61, further comprising:
a) a power take-off location driven by the first or second countershaft.
